(19) United States
(12) Patent Application Publication
(10) Pub. No.: US 2019/0069481 A1
(43) Pub. Date: Mar. 7, 2019

(54) Attachment plate for supporting walk behind trimmers with third wheel

(71) Applicants: Huan Zeppelin Vuong, Richman, VA (US); Daniel Victor Vuong, Key West, FL (US)

(72) Inventors: Huan Zeppelin Vuong, Richman, VA (US); Daniel Victor Vuong, Key West, FL (US)

(21) Appl. No.: 16/016,350

(22) Filed: Jun. 22, 2018

Related U.S. Application Data
(60) Provisional application No. 62/523,705, filed on Jun. 22, 2017.

(51) Int. Cl. A01D 34/82; A01D 34/416; A01D 34/81

(52) U.S. Cl. CPC A01D 34/82; A01D 2101/00; A01D 34/81; A01D 34/4165

(57) ABSTRACT

A trimmer and mower which utilizes a string cutting type apparatus includes a stabilizing third wheel positioned ahead of the trimmer head which enables safer and easier manipulation and control of the trimmer. The trimmer and mower includes a third wheel attachment apparatus which provides increased strength and rigidity of the motor support platform and more reliably protects the operative components of the trimmer and mower supported on the underside of the engine support platform.

### CROSS-REFERENCE TO RELATED APPLICATION

This application claims the benefit of and priority under 35 U.S.C. 119(e) of U.S. Provisional Patent Application No. 62/523,705 entitled STABILIZING THIRD WHEEL FOR STRING TRIMMER, filed Jun. 22, 2017 in the name of Daniel Victor Vuong, the disclosure of which is incorporated herein by reference.

### FIELD OF THE INVENTION

This invention relates generally to mowers and trimmers utilized in landscaping activities and relates particularly to devices characterized as walk behind two-wheeled, gas powered string trimmers and mowers (collectively hereinafter “string trimmers”).

### BACKGROUND OF THE INVENTION

For many years practitioners in the art have endeavored to provide trimmers and mowers suitable for use in cutting rough weed dominated portions of the property. Of particular concern has been providing trimmers and mowers which are able to operate in cutting tall thickly weeded portions of property often characterized as uneven ground which is difficult to effectively cut and control the densely weeded portions. Examples of such difficult trimming and mowing challenges are often found where more carefully tended landscape portions of but obstacles such as fences, walls or large rocky areas.

While a great number of different apparatus designs have been created by practitioners in their efforts to meet this need, most commercially available trimmers and mowers suitable for such use have settled upon a common basic design in which a frame supports an engine platform upon which a small gasoline internal combustion engine is fixed. The engine is supported upon the engine platform in an arrangement that directs the engine output shaft downwardly through an aperture in the platform. The lower end of the engine output shaft is coupled to a trimmer head rotatable beneath the platform. In most designs, a pulley and belt apparatus couples the engine output shaft to the trimmer head. The trimmer head further supports a plurality of elongated generally flexible filamentary cutting elements, often referred to as “strings”. In addition the bottom end of the trimmer head supports a convexly curved bumper. A trimmer shroud extends downwardly from the periphery of the engine platform to protect the user from debris cast away from the rotating trimmer had and strings. A pair of large diameter wheels are positioned behind the engine platform to provide rolling support for the trimmer. Finally, an elongated generally U-shaped handle extends upwardly and rearwardly from the engine platform to allow the user to walk behind the trimmer and to push and manipulate the trimmer. Because the user walks behind the trimmer and pushes and/or steers the trimmer, such trimmers are often called “walk behind” trimmers.

In operation, the engine operates through the pulley and belt apparatus to rapidly spin the trimmer head and the string filaments to provide a cutting action. The operator holds the handle and pushes and guides the trimmer directing it against the vegetation for which cutting or trimming is desire. Because the engine is positioned ahead of the rear wheels, the weight of the engine causes the trimmer to pitch downwardly in front bringing the bumper of the trimmer head into contact with the underlying ground surface. The position of the trimmer head bumper is intended by manufacturers to maintain the trimmer in a generally level attitude. Unfortunately, this aspect of the trimmer design has proven to be unsatisfactory in use and is often plagued with multiple problems.

For example, when the trimmer is utilized on relatively uneven or rough ground, the trimmer head bumper often catches against or becomes embedded within the underlying ground. In addition, the user must often manipulate the trimmer handle to raise and lower the angle of the trimmer as the elevation of the underlying terrain varies. That is to say, the use of the trimmer head bumper and rearward supporting wheels does not allow the trimmer to readily follow variations of the underlying ground.

These problems often combine to increase the effort and difficulty required by the user in pushing and controlling the trimmer. In addition, it becomes very difficult to maintain a relatively even height of trim or cut. Further, excessive contact with objects on the ground against the trimmer head may damage the trimmer head and render the trimmer in operative. Finally, and perhaps most importantly, the action of the trimmer head bumper and the difficulty of manipulation and control which it may create may also result in a safety hazard to the user as the user awkwardly struggles to control the trimmer.

In attempting to overcome these various problems that limit the utility and ease of use of string trimmers and mowers, practitioners in the art have endeavored to improve the designs thereof. By way of example, US published patent application 2009/0049818 A1 filed on behalf of Farquhar and entitled WHEEL GUIDED LAWN TRIMMER sets forth a lawn trimmer having a base platform supporting a motor coupled to a rotatably supported cutting string head and supported by a pair of rear wheels. An elongated handle extends rearwardly and upwardly from the platform and is used to guide the lawn trimmer. A third wheel is supported upon a forwardly extending bracket which in turn is secured to the top surface of the forward portion of the platform.

U.S. Pat. No. 3,382,653 issued to Buigne and entitled POWER DRIVEN ROTARY MOWER sets forth a power mower having a platform supported by a pair of articulated rear wheel's. A handle extends upwardly and rearwardly from the platform and includes a linkage coupled to the rear wheels which facilitate steering the mower. The forward portion of the platform supports a forwardly extending bracket which in turn supports a caster wheel.

U.S. Pat. No. 2,564,201 issued to Hainke and entitled WHEEL ADJUSTMENT FOR LAWN MOWERS sets forth a lawnmower having a motor supporting platform and a belt driven rotating cutting blade supported beneath the engine platform. The mower further includes a pair of rear wheels together with a forwardly extending caster wheel. A handle extends upwardly and rearwardly from the engine platform and a linkage extends from the handle to the front mounted caster wheel to facilitate adjustment of the caster wheel height.

U.S. Pat. No. 7,617,661 issued to Faeldan and entitled TRI-WHEELED MODULAR HOUSING TELESCOPIC GRASS TRIMMER sets forth a three wheeled grass trimmer in which a front wheel is supported upon a telescoping extendable support.

U.S. Pat. No. 6,233,912 issued to Eubanks and entitled IMPLEMENT DECK THAT SHIFTS LATERALLY FROM SIDE TO SIDE sets forth a lawnmower having a engine platform and rotating cutting blade beneath the engine platform together with a pair of rear support wheels. The mower is further supported by a third wheel secured to the upper surface of the engine platform by a forwardly extending bracket. A handle extends upwardly and rearwardly from the engine platform and is coupled to a linkage which facilitates lateral shifting of the rear wheels with respect to the engine platform.

While the foregoing described prior art devices have, to some extent, improved the art and, in some instances, enjoyed commercial success, there remains nonetheless a continuing need in the art for evermore improved, more easily guided and more easily operated string type lawn trimmers and mowers.

### SUMMARY OF THE INVENTION

Accordingly, it is a general object of the present invention to provide an improved trimmer and mower. It is a more particular object of the present invention to provide an improved trimmer and mower which utilizes a string cutting type apparatus having a stabilizing third wheel positioned ahead of the trimmer head which enables safer and easier manipulation and control of the trimmer. It is a still more particular object of the present invention to provide an improved trimmer and mower which utilizes a string cutting type apparatus which includes increased strength and rigidity of the motor support platform and which more reliably protects the operative components of the trimmer and mower supported on the underside of the motor support platform.

In accordance with the present invention there is provided a stabilizing third wheel assembly for a string trimmer and mower which utilizes an elongated support bracket secured to the underside of the motor support platform of the host trimmer which extends forwardly and which supports a caster wheel extending downwardly from the support bracket. The support bracket is secured to the underside of the motor support platform shroud and defines an aperture through which the engine output shaft extends to support the trimmer head. The caster wheel support frame is sufficient in length to ensure that the caster wheel is positioned beyond the travel path of the cutting strings. The support bracket is formed of a high strength material and defines sufficient strength and rigidity to protect the underside mower components and greatly increase the strength and rigidity of the motor support platform.

In further accordance with the present invention there is provided for use in combination with a trimmer having an engine platform defining an undersurface, a protective shroud defining a bottom surface secured to said undersurface, an engine supported upon said engine platform, a trimmer head drive apparatus coupled to said engine, a trimmer head supported by said trimmer head drive apparatus beneath said undersurface, a stabilizing wheel and attachment comprising: a plurality of extended length fasteners; a caster wheel having a caster wheel attachment shall extending therefrom; and an attachment bracket formed of a substantially rigid high strength generally planar member defining a plurality of fastener apertures, a trimmer head aperture and a caster wheel attachment shaft aperture, the attachment bracket being constructed to be received against the bottom surface of the protective shroud and secured to the engine platform by the plurality of extended length fasteners to captivate the protective shroud against the undersurface and the caster wheel being secured to the attachment bracket by the attachment of the caster wheel attachment shaft within the caster wheel attachment shaft aperture and the trimmer head drive apparatus extending through the trimmer head aperture.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a side elevation view of a string trimmer to which a stabilizing third wheel assembly constructed in accordance with the present invention has been secured;

FIG. 2 sets forth a bottom perspective view of the underside of the string trimmer and stabilizing third wheel assembly shown in FIG. 1;

FIG. 3 sets forth a top view of the caster wheel support bracket of the present invention stabilizing third wheel assembly;

FIG. 4 sets forth a right side view of the caster wheel support bracket shown in FIG. 3;

FIG. 5 sets forth a top view of the caster wheel support bracket of an alternate embodiment of the present invention stabilizing third wheel assembly for use in combination with an Ariens brand machine;

FIG. 6 sets forth a top view of the caster wheel support bracket of a further alternate embodiment of the present invention stabilizing third wheel assembly for use in combination with a Cobra brand machine;

FIG. 7 sets forth a top view of the caster wheel support bracket of a still further alternate embodiment of the present invention stabilizing third wheel assembly for use in combination with a Craftsman brand machine;

FIG. 8 sets forth a top view of the caster wheel support bracket of a still further alternate embodiment of the present invention stabilizing third wheel assembly for use in combination with a Cub Cadet brand machine;

FIG. 9 sets forth a top view of the caster wheel support bracket of a still further alternate embodiment of the present invention stabilizing third wheel assembly for use in combination with a Dierty Hand Tool brand machine;

FIG. 10 sets forth a top view of the caster wheel support bracket of a still further alternate embodiment of the present invention stabilizing third wheel assembly for use in combination with a DR Trimmer brand machine;

FIG. 11 sets forth a top view of the caster wheel support bracket of a still further alternate embodiment of the present invention stabilizing third wheel assembly for use in combination with a Echo Bear Cat brand machine;

FIG. 12 sets forth a top view of the caster wheel support bracket of a still further alternate embodiment of the present invention stabilizing third wheel assembly for use in combination with a Field Edge brand machine;

FIG. 13 sets forth a top view of the caster wheel support bracket of a still further alternate embodiment of the present invention stabilizing third wheel assembly for use in combination with a Generac brand machine;

FIG. 14 sets forth a top view of the caster wheel support bracket of a still further alternate embodiment of the present invention stabilizing third wheel assembly for use in combination with a Husqvarna brand machine;

FIG. 15 sets forth a top view of the caster wheel support bracket of a still further alternate embodiment of the present invention stabilizing third wheel assembly for use in combination with a Huyndai brand machine;

FIG. 16 sets forth a top view of the caster wheel support bracket of a still further alternate embodiment of the present invention stabilizing third wheel assembly for use in combination with a Maxxim brand machine;

FIG. 17 sets forth a top view of the caster wheel support bracket of a still further alternate embodiment of the present invention stabilizing third wheel assembly for use in combination with a Poulan Pro brand machine;

FIG. 18 sets forth a top view of the caster wheel support bracket of a still further alternate embodiment of the present invention stabilizing third wheel assembly for use in combination with a Powermate brand machine;

FIG. 19 sets forth a top view of the caster wheel support bracket of a still further alternate embodiment of the present invention stabilizing third wheel assembly for use in combination with a Reminaton brand machine;

FIG. 20 sets forth a top view of the caster wheel support bracket of a still further alternate embodiment of the present invention stabilizing third wheel assembly for use in combination with a Sarlo brand machine;

FIG. 21 sets forth a top view of the caster wheel support bracket of a still further alternate embodiment of the present invention stabilizing third wheel assembly for use in combination with a Southland brand machine;

FIG. 22 sets forth a top view of the caster wheel support bracket of a still further alternate embodiment of the present invention stabilizing third wheel assembly for use in combination with a Swisher brand machine; and

FIG. 23 sets forth a top view of the caster wheel support bracket of a still further alternate embodiment of the present invention stabilizing third wheel assembly for use in combination with a Troy Bilt brand machine.

### DESCRIPTION OF THE PREFERRED EMBODIMENT

By way of overview, the present invention is configured for attachment to an otherwise conventional string type trimmer and mower utilizing the existing fasteners assembled to the trimmer together with increased length replacement fasteners. The present invention provides a stabilizing third wheel assembly comprising a support bracket preferably formed of a suitable metal, such as steel or aluminum, or other material having efficient strength and rigidity, together with a caster wheel secured to the undersurface of the support bracket. In certain applications, a simple rotatably supported wheel may be utilized. However, it has been found that in the preferred fabrication of the present invention, a caster wheel is more suitable due to its ability to pivot in response to lateral forces as the user seeks to pivot and otherwise maneuver the host trimmer. The caster wheel extends downwardly a sufficient distance to maintain a clearance between the convex bumpers surface of the trimmer head thereby avoiding undesired contact between the bottom surface of the trimmer head and the underlying ground. The caster wheel functions to adjust the pitch and angle of the trimmer as variations of contour and elevation of the underlying terrain are encountered.

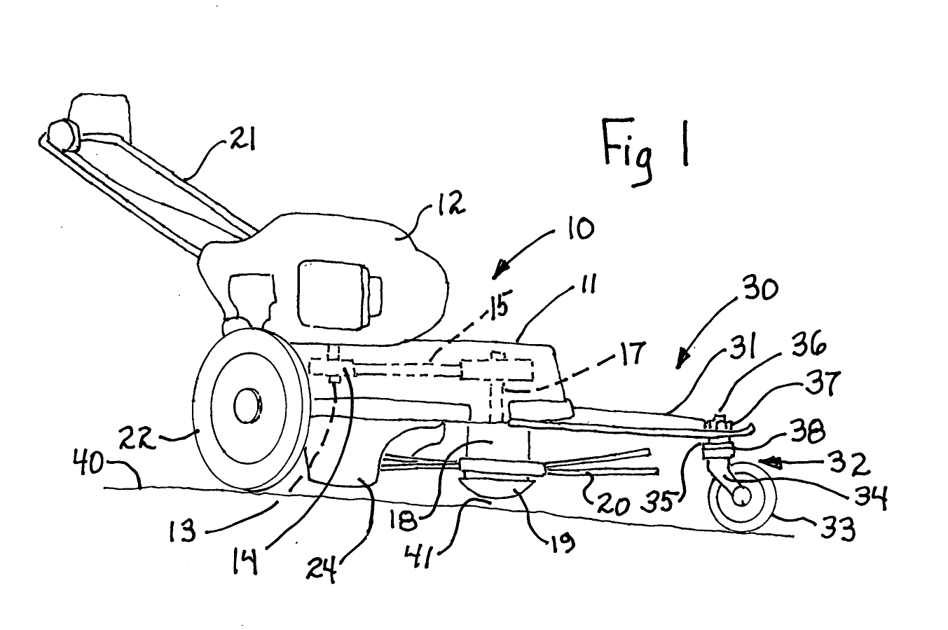

FIG. 1 sets forth a side elevation view of a trimmer, generally referenced by numeral 10, in combination with a stabilizing third wheel assembly, constructed in accordance with the present invention and generally referenced by numeral 30. Trimmer 10 may be constructed in accordance with conventional fabrication techniques.

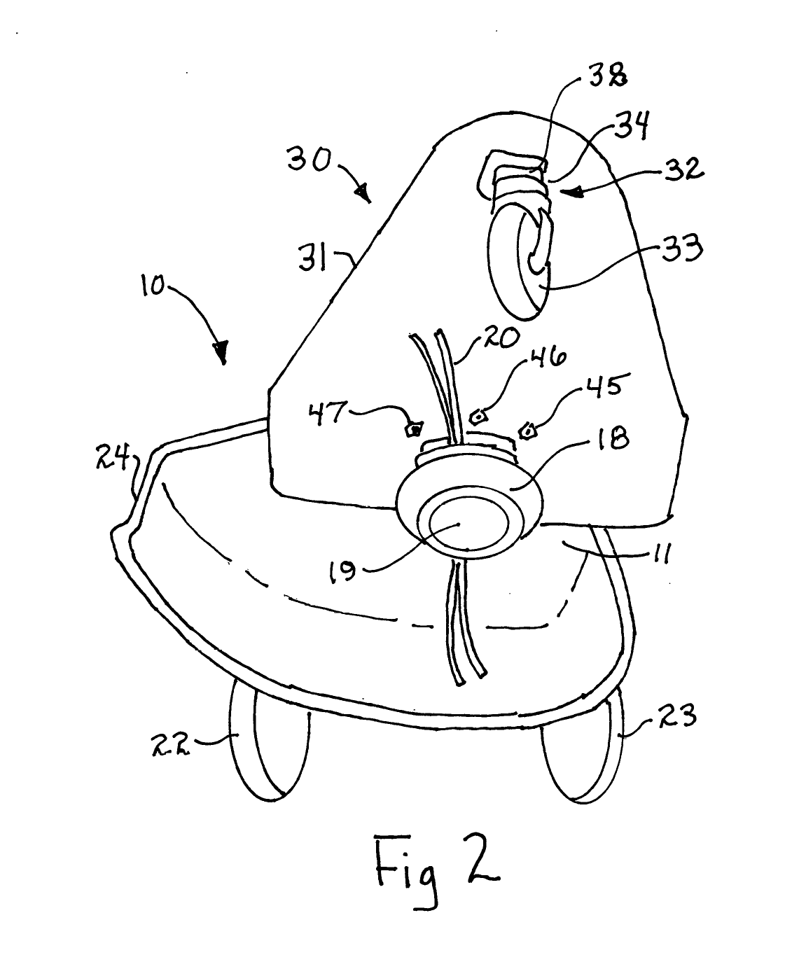

Thus, trimmer 10 includes an engine platform 11 supporting an internal combustion engine 12 together with a rearwardly and upwardly extending handle 21. Engine platform 11 further supports a downwardly extending shroud 24 and a pair of rear wheels 22 and 23 (wheel 23 seen in FIG. 2). Engine 12 includes a downwardly extending engine shaft 13 which in turn supports an output pulley 14. Engine platform 11 further supports a trimmer had shaft 17 which in turn supports a pulley 16. A belt 15 encircles pulleys 14 and 16 to provide a power coupling therebetween. A trimmer head 18 is positioned on the underside of engine platform 11 and is rotatably supported by trimmer head shaft 17. Trimmer head 18 further supports a plurality of flexible cutting strings 20 and a convexly curved bumper head 19.

As described thus far, trimmer 10 may be fabricated entirely in accordance with conventional fabrication techniques and it will be recognized by those skilled in the art that trimmer 10 is provided solely for purposes of illustration to give an example of an operative environment for the present invention stabilizing third wheel as indicated by third wheel assembly 30. Thus, it will be apparent to those skilled in the art that alternative gas powered trimmer devices may be used in place of trimmer 10 without departing from the spirit and scope of the present invention.

In accordance with the present invention, stabilizing third wheel assembly 30 includes a caster wheel support bracket 31 secured to the underside of engine platform 11 in the manner set forth below in FIG. 2. Stabilizing third wheel assembly 30 further includes a caster wheel 32 supporting a wheel 33 upon a caster yoke 34. Yoke 34 further includes an upwardly extending caster shaft 35 which passes through an aperture formed in support bracket 31 and terminates in a threaded end 36. A threaded nut 37 is received upon threaded end 36 to secure shaft 35 upon support bracket 31. A bearing 38 couples the lower and a shaft 35 to the upper side of caster yoke 34 in a rotatable attachment that allows caster wheel 32 to pivot in a typical caster manner. This use of caster wheel 32 aids in the pivoting and manipulation of trimmer 10 as caster wheel 32 responds to the direction of force applied in accordance with the characteristics of a caster wheel.

In accordance with the preferred fabrication of the present invention the relative sizes of wheels 22 and 23 together with the downward extension of caster wheel 32 are selected to maintain a clearance space 41 between trimmer head bumper 19 and ground surface 40. Thus, in the preferred use of the present invention trimmer 10 is moved upon ground 40 by the rolling actions of wheels 22 and 23 together with caster wheel 32.

FIG. 2 sets forth a bottom view of trimmer 10 together with stabilizing third wheel assembly 30. As described above, trimmer 10 includes an engine platform 11 from which a shroud 24 extends downwardly to provide protection from objects influenced by the rotating cutter strings of the trimmer. Shroud 24 is preferably formed of a high strength materials such as molded plastic or a suitable metal. As is also described above a trimmer head 18 is rotatably supported beneath engine platform 11 extending downwardly within shroud 24. Trimmer head 18 further supports a bumper 19 which defines a convexly curved bumper surface. Trimmer head 18 further supports a plurality of flexible cutting strings 20.

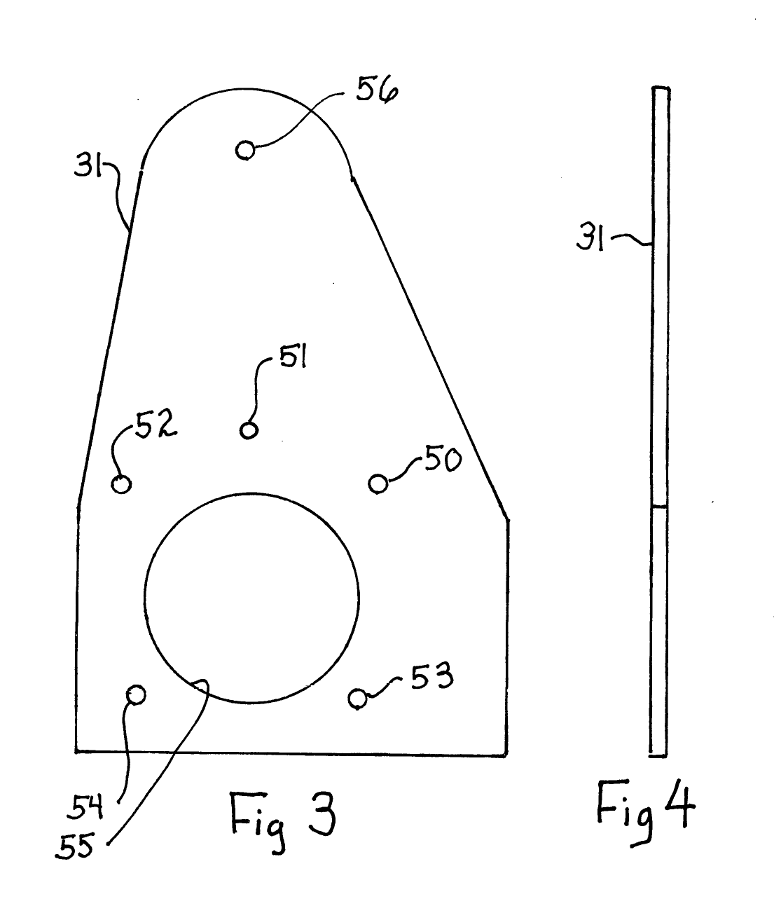

As is also mentioned above, trimmer 10 further supports a stabilizing third wheel assembly 30 constructed in accordance with the present invention which is secured to the underside of engine platform 11. A plurality of fastening bolts such as bolts 45, 46 and 47 extend downwardly from engine platform 11 and pass respectively through apertures 50, 51 and 52 formed in support bracket 31 (apertures 50, 51 and 52 seen in FIG. 3). Wheels 22 and 23 rotatably support trimmer 10 in the manner shown above in FIG. 1.

In accordance with an important aspect of the present invention, it will be noted that support bracket 31 covers a substantial portion of shroud 24 and the undersurface of engine platform 11. Because of the utilization of a substantially rigid high strength material such as steel or aluminum or the like to fabricate support bracket 31, the attachment thereof to the underside of engine platform 11 and the captivation of shroud 24 greatly increases the strength and rigidity of engine platform 11 while simultaneously protecting and strengthening shroud 24. In addition, it will be appreciated that the forward extension of support bracket 31 and the downward extension of caster wheel 32 protects the trimmer head against impact with the ground surface during trimming and mowing activities.

FIG. 3 sets forth a top view of caster wheel support bracket 31 of stabilizing third wheel assembly 30. Support bracket 31 is preferably formed of a substantially rigid material such as aluminum, steel or other suitable material and may be formed in a generally planar configuration (seen in FIG. 4). As is shown in FIG. 2, support bracket 31 is received beneath engine platform 11 and shroud 24 and is secured utilizing a plurality of fastening bolts such as bolts 45, 46 and 47 shown in FIG. 2. Support bracket 31 defines an aperture 55 sufficient in size to receive trimmer head 18 and allow trimmer head 18 to extend through support bracket 31. Support bracket 31 further defines a plurality of apertures 50 through 54 positioned in relation to aperture 55 to facilitate receiving a plurality of threaded fasteners to secure support bracket 31 in the manner seen in FIG. 2. Support bracket 31 further defines an aperture 56 which facilitates the attachment of caster wheel 32 in the manner shown in FIG. 1. Thus, aperture 56 is of sufficient size to receive threaded end 36 of shaft 35 (seen in FIG. 1) to facilitate mounting caster wheel 32 to the forward portion of support bracket 31 in the manner also seen in FIGS. 1 and 2.

FIG. 4 sets forth a right side view of caster wheel support bracket 31 shown in FIG. 3. Of importance to note is the generally planar construction of caster wheel support bracket 31. It will be understood that each of the alternate embodiment caster wheel support brackets set forth below in FIGS. 5 through 23 are preferably fabricated in the same planar manner as caster wheel support bracket 31 shown in FIG. 4.

FIGS. 5 through 23 set forth respective top views of alternative embodiments of the present invention which accommodate different brands of commercially available string trimmers and mowers. The alternate embodiment shown are similar in that they comprise planar rigid caster wheel support brackets utilized in the manner that caster wheel support bracket 31 is set forth in FIGS. 1 through 3. Thus, each of the alternate embodiment caster wheels support brackets shown in FIGS. 5 through 23 will be understood to define rigid generally planar members with the differences there between being found in the geometry and aperture placement and arrangement acquired to accommodate the specific brand of trimmer and mower machine for which they are intended to be utilized. To facilitate the description and illustration of each caster wheel support bracket in FIGS. 5 through 23, Cartesian coordinate indicia are provided in each figure allowing the location of apertures formed therein to be indicated in accordance with x and y coordinates of the aperture centers. To facilitate this Cartesian coordinate indicia horizontal (x axis) and vertical (y axis) reference axes are shown in each figure.

FIG. 5 sets forth a top view of the caster wheel support bracket of the present invention stabilizing third wheel assembly for use in combination with an Ariens brand machine generally referenced by numeral 61. FIG. 5 also shows the above-mentioned horizontal axis 60 and the above-mentioned vertical axis 70 as well as an origin 80 formed at the intersection of axes 60 and 70. It will be understood that the respective X and Y coordinates at origin 80 are both zero (0,0). It will also be understood that the respective X and Y coordinates for the centers of each aperture will be similarly expressed as (x,y) in the descriptions which follow.

Accordingly, caster wheel support bracket 61 is shown having a bottom edge 68 positioned along horizontal axis 60 and a left side edge 69 positioned along vertical axis 70. Caster wheel support bracket 61 defines a trimmer shaft aperture 62 having a diameter of 5.1 inches and a center at (10.830,4.040). Caster wheel support bracket 61 further defines a plurality of apertures 64, 65, 66 and 67 each having diameters of 0.54 inches and having aperture centers at coordinates (5,3.214). (6.150,6.560), (9.753,6.56) and (10.830,3.214). Caster wheel support bracket 61 further defines a caster wheel shaft aperture 63 having a diameter of 0.57 inches and an aperture center at (8,16.146).

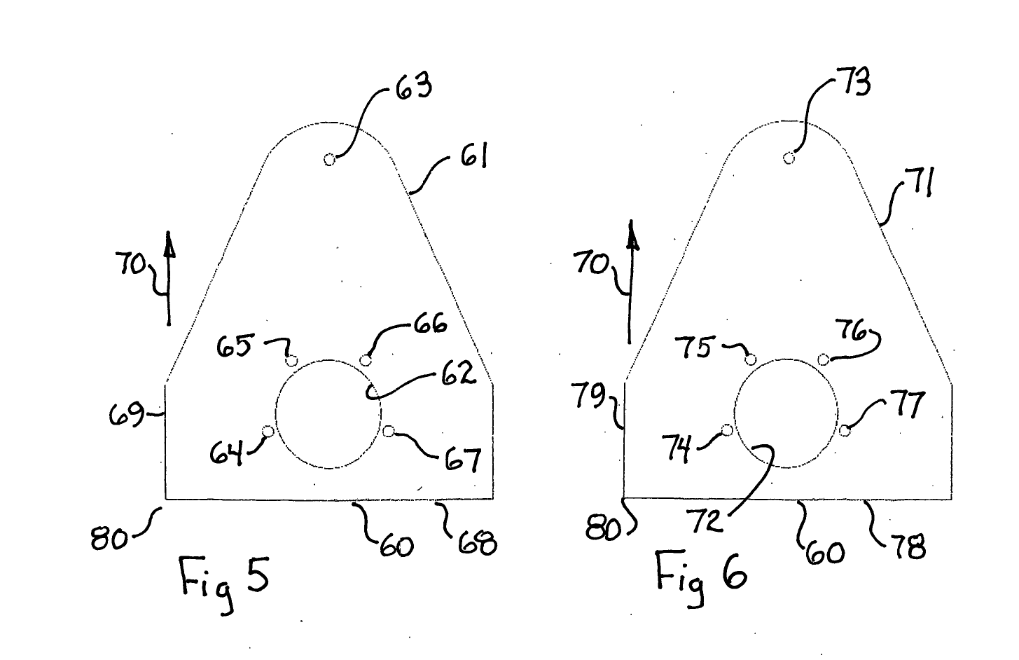

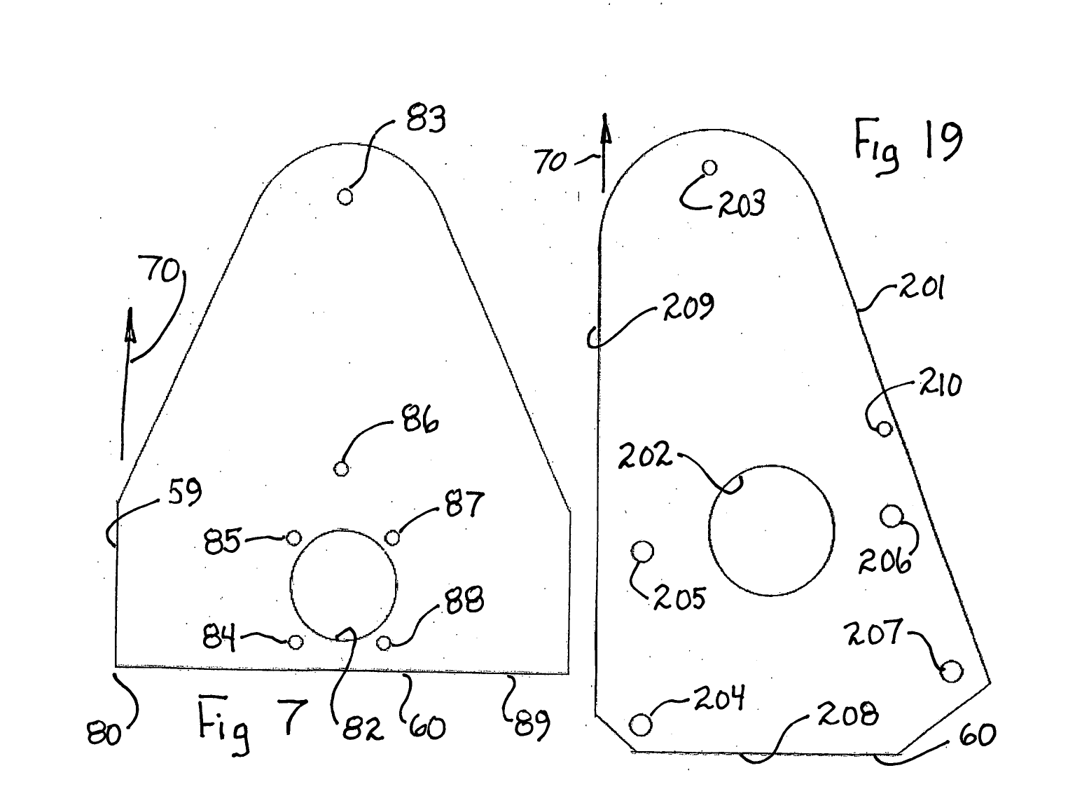

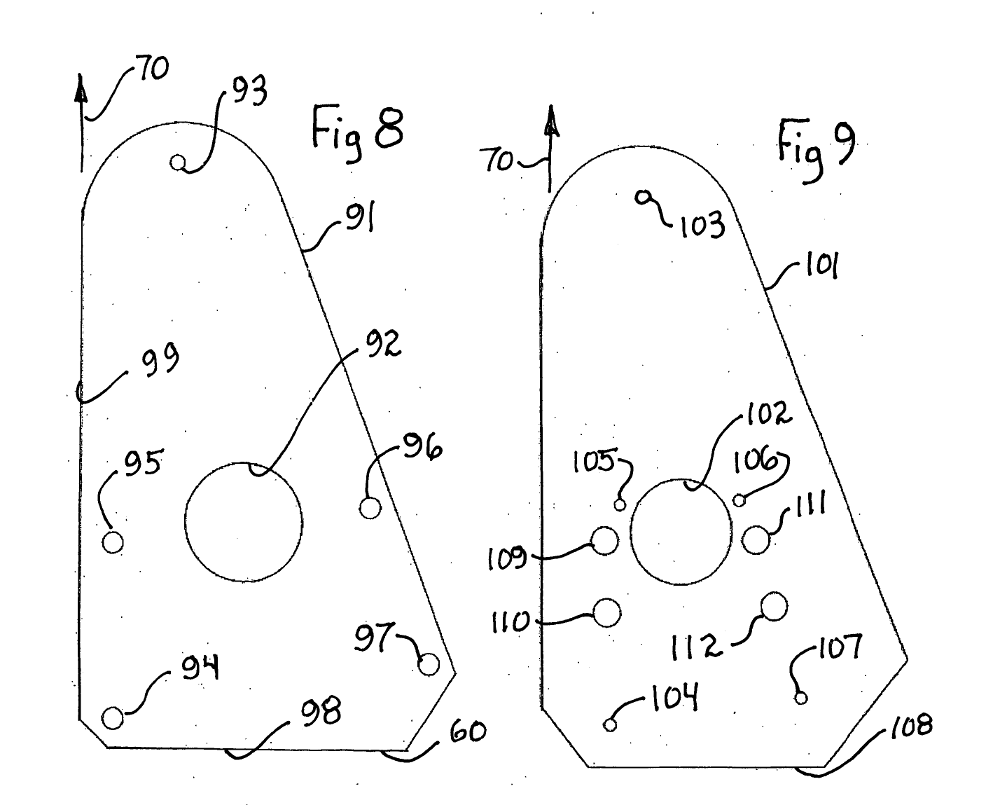

FIG. 6 sets forth a top view of the caster wheel support bracket 71 of the present invention stabilizing third wheel assembly for use in combination with a Cobra brand machine. Caster wheel support bracket 71 is shown having a bottom edge 78 positioned along horizontal axis 60 and a left side edge 79 positioned along vertical axis 70. Caster wheel support bracket 71 defines a trimmer shaft aperture 72 having a diameter of 5.1 inches and a center at (7.920,4.040). Caster wheel support bracket 71 further defines a plurality of apertures 74, 75, 76 and 77 each having diameters of 0.54 inches and having aperture centers at coordinates (5,3.214). (6.150,6.560), (9.753,6.56) and (10.830,3.214). Caster wheel support bracket 71 further defines a caster wheel shaft aperture 73 having a diameter of 0.57 inches and an aperture center at (8,16.146).

FIG. 7 sets forth a top view of the caster wheel support bracket 81 of the present invention stabilizing third wheel assembly for use in combination with a Craftsman brand machine. Caster wheel support bracket 81 is shown having a bottom edge 89 positioned along horizontal axis 60 and a left side edge 59 positioned along vertical axis 70. Caster wheel support bracket 81 defines a trimmer shaft aperture 82 having a diameter of 3.75 inches and a center at (8,2.875). Caster wheel support bracket 81 further defines a plurality of apertures 84, 85, 86, 87 and 88 each having diameters of 0.48 inches and having aperture centers at coordinates (6.325,0.950). (6.222,4.484), (7.875,6.830), (9.725,4.530) and (9.455,0.950). Caster wheel support bracket 81 further defines a caster wheel shaft aperture 83 having a diameter of 0.57 inches and an aperture center at (8,16.149).

FIG. 8 sets forth a top view of the caster wheel support bracket 91 of the present invention stabilizing third wheel assembly for use in combination with a Cub Cadet brand machine. Caster wheel support bracket 91 is shown having a bottom edge 98 positioned along horizontal axis 60 and a left side edge 99 positioned along vertical axis 70. Caster wheel support bracket 91 defines a trimmer shaft aperture 92 having a diameter of 4.57 inches and a center at (6.875,8.553). Caster wheel support bracket 91 further defines a plurality of apertures 94, 95, 96 and 97 each having diameters of 0.37 inches and having aperture centers at coordinates (1.750,1.000). (1.750,7.688), (11.873,9.168) and (14.220,3.200). Caster wheel support bracket 91 further defines a caster wheel shaft aperture 93 having a diameter of 0.57 inches and an aperture center at (4,22.500).

FIG. 9 sets forth a top view of the caster wheel support bracket 101 of the present invention stabilizing third wheel assembly for use in combination with a Dierty Hand Tool brand machine. Caster wheel support bracket 101 is shown having a bottom edge 108 positioned along horizontal axis 60. Caster wheel support bracket 101 defines a trimmer shaft aperture 102 having a diameter of 4.074 inches and a center at (9.033,9.030). Caster wheel support bracket 101 further defines a plurality of apertures 104, 105, 106 and 107 each having diameters of 0.46 inches and having aperture centers at coordinates (4.250,2.650). (6.709,10.250), (11.479,10.065) and (11.859,1.620). Caster wheel support bracket 101 further defines a caster wheel shaft aperture 103 having a diameter of 0.57 inches and an aperture center at (8,22). Caster wheel support bracket 101 further defines a plurality of apertures 109, 110, 111 and 112 each having a diameter of 1.06 inches.

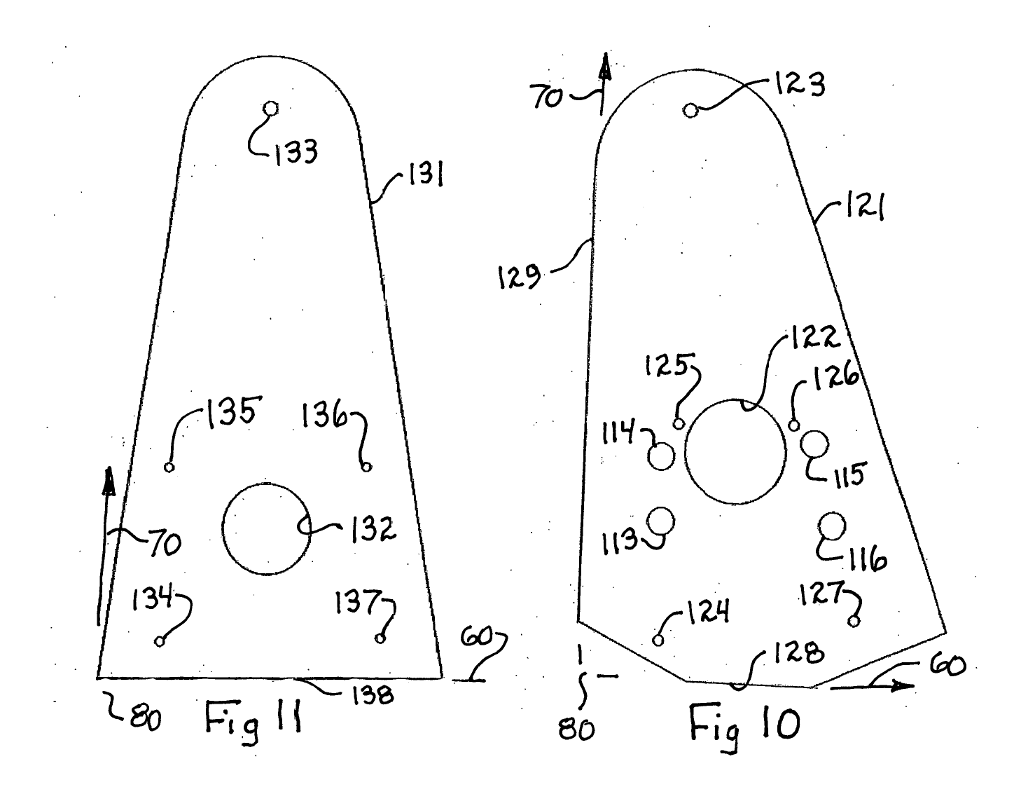

FIG. 10 sets forth a top view of the caster wheel support bracket 121 of the present invention stabilizing third wheel assembly for use in combination with a DR Trimmer brand machine. Caster wheel support bracket 101 is shown having a bottom edge 108 positioned along horizontal axis 60 and a side edge 129 positioned along vertical axis 70. Caster wheel support bracket 121 defines a trimmer shaft aperture 122 having a diameter of 4.094 inches and a center at (5.512,8.661). Caster wheel support bracket 121 further defines a plurality of apertures 124, 125, 126 and 127 each having diameters of 0.406 inches. Caster wheel support bracket 121 further defines a caster wheel shaft aperture 123 having a diameter of 0.57 inches and an aperture center at (3.5,22). Caster wheel support bracket 121 further defines a plurality of apertures 113, 114, 115 and 116 each having a diameter of 1.066 inches.

FIG. 11 sets forth a top view of the caster wheel support bracket 131 of the present invention stabilizing third wheel assembly for use in combination with a Echo Bear Cat brand machine. Caster wheel support bracket 131 is shown having a bottom edge 138 positioned along horizontal axis 60. Caster wheel support bracket 131 defines a trimmer shaft aperture 132 having a diameter of 3.474 inches and a center at (7.790,5.7). Caster wheel support bracket 131 further defines a plurality of apertures 134, 135, 136 and 137 each having diameters of 0.35 inches and having aperture centers at coordinates (3.445,1.404). (3.895,8.061), (11.750,8.105) and (12.253,0.175). Caster wheel support bracket 131 further defines a caster wheel shaft aperture 133 having a diameter of 0.57 inches and an aperture center at (9,21.943).

FIG. 12 sets forth a top view of the caster wheel support bracket 141 of the present invention stabilizing third wheel assembly for use in combination with a Field Edge brand machine. Caster wheel support bracket 141 is shown having a bottom edge 148 positioned along horizontal axis 60 and a left side edge 149 positioned along vertical axis 70. Caster wheel support bracket 141 defines a trimmer shaft aperture 142 having a diameter of 5.1 inches and a center at (7.920,4.040). Caster wheel support bracket 141 further defines a plurality of apertures 144, 145, 146 and 147 each having diameters of 0.54 inches and having aperture centers at coordinates (5,3.214). (6.150,6.560), (9.753,6.56) and (10.830,3.214). Caster wheel support bracket 71 further defines a caster wheel shaft aperture 143 having a diameter of 0.57 inches and an aperture center at (8,16.146).

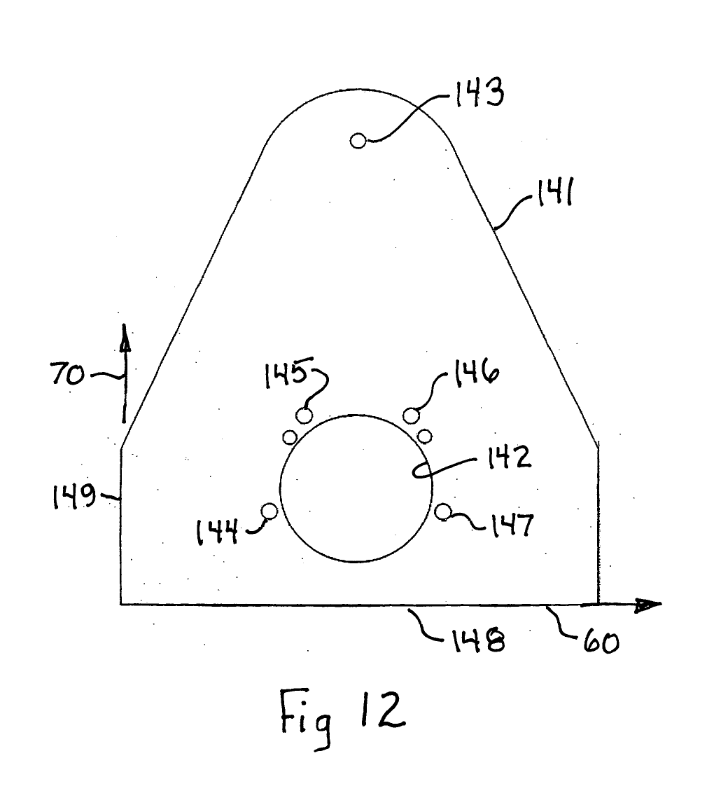

FIG. 13 sets forth a top view of the caster wheel support bracket 151 of the present invention stabilizing third wheel assembly for use in combination with a Generac brand machine. Caster wheel support bracket 151 is shown having a bottom edge 158 positioned along horizontal axis 60. Caster wheel support bracket 151 defines a trimmer shaft aperture 152 having a diameter of 4.08 inches and a center at (9.033,9.030). Caster wheel support bracket 151 further defines a plurality of apertures 154, 155, 156 and 157 each having diameters of 0.40 inches and having aperture centers at coordinates (3.370,2.660). (6.709,10.190), (11.387,10.020) and (11.857,1.490). Caster wheel support bracket 151 further defines a caster wheel shaft aperture 153 having a diameter of 0.57 inches and an aperture center at (8,22). Caster wheel support bracket 151 further defines a plurality of apertures 160, 161, 162 and 163 each having a diameter of 1.06 inches.

FIG. 14 sets forth a top view of the caster wheel support bracket 171 of the present invention stabilizing third wheel assembly for use in combination with a Husqvarna brand machine. Caster wheel support bracket 171 is shown having a bottom edge 179 positioned along horizontal axis 60 and a left side edge 170 positioned along vertical axis 70. Caster wheel support bracket 171 defines a trimmer shaft aperture 172 having a diameter of 3.75 inches and a center at (8,2.875). Caster wheel support bracket 171 further defines a plurality of apertures 174, 175, 176, 177 and 178 each having diameters of 0.48 inches and having aperture centers at coordinates (6.325,0.950). (6.222,4.484), (7.875,6.830), (9.725,4.530) and (9.455,0.950). Caster wheel support bracket 171 further defines a caster wheel shaft aperture 173 having a diameter of 0.57 inches and an aperture center at (8,16.149).

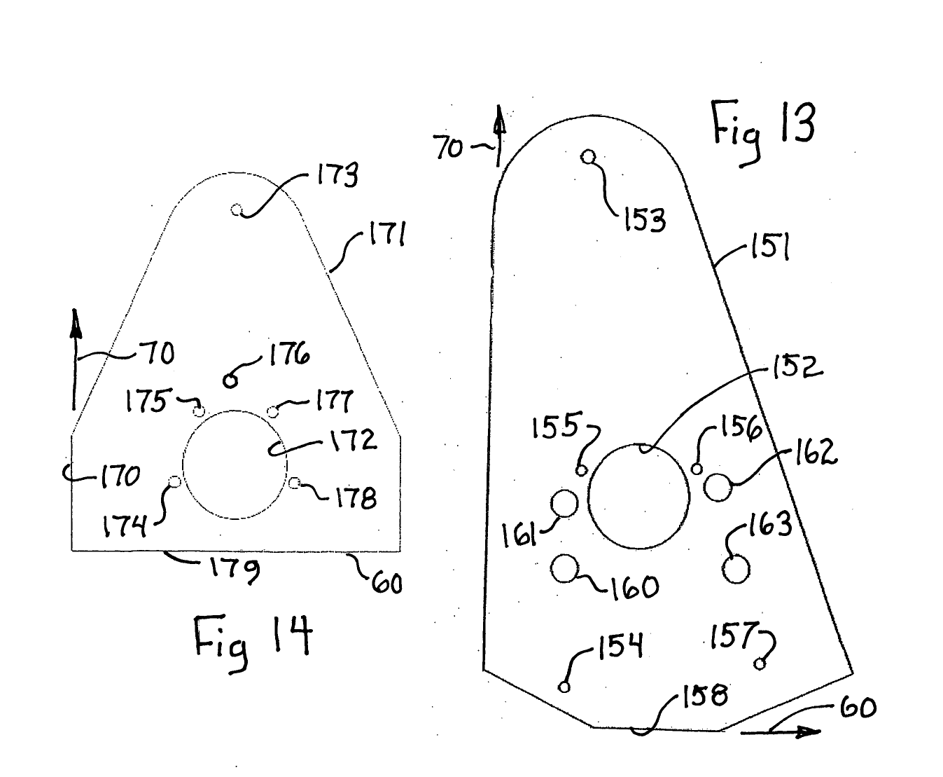

FIG. 15 sets forth a top view of the caster wheel support bracket 180 of the present invention stabilizing third wheel assembly for use in combination with a Huyndai brand machine. Caster wheel support bracket 180 is substantially identical to caster wheel support bracket 171 shown in FIG. 14.

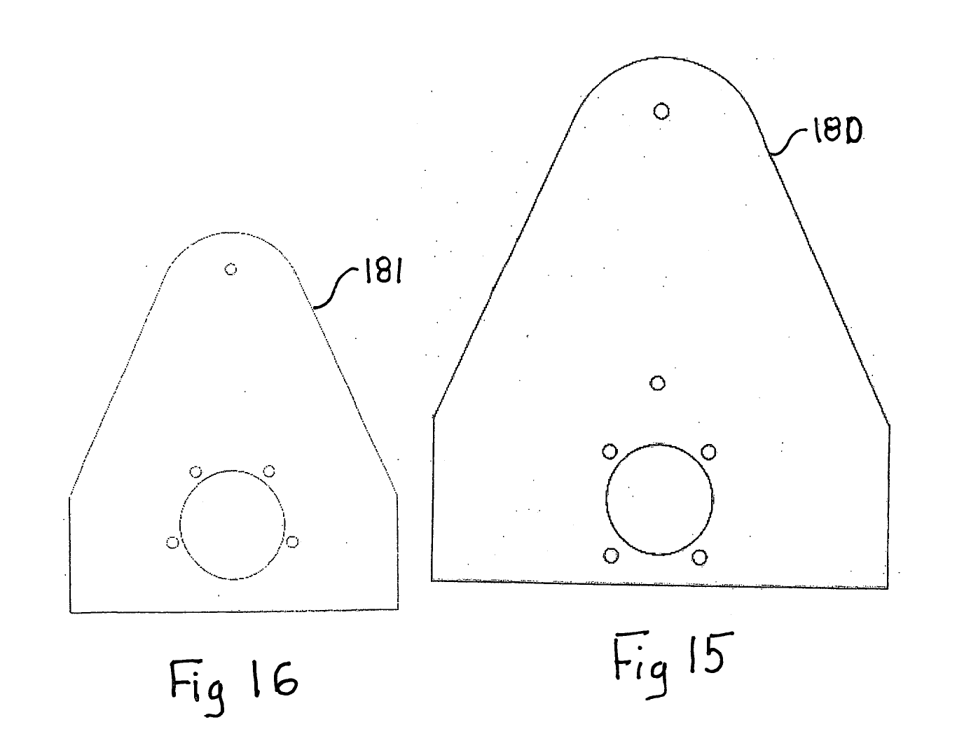

FIG. 16 sets forth a top view of the caster wheel support bracket 181 of the present invention stabilizing third wheel assembly for use in combination with a Maxxim brand machine. Caster wheel support bracket 181 is substantially identical to caster wheel support bracket 71 shown in FIG. 6.

FIG. 17 sets forth a top view of the caster wheel support bracket 182 of the present invention stabilizing third wheel assembly for use in combination with a Poulan Pro brand machine. Caster wheel support bracket 182 is substantially identical to caster wheel support bracket 81 shown in FIG. 7.

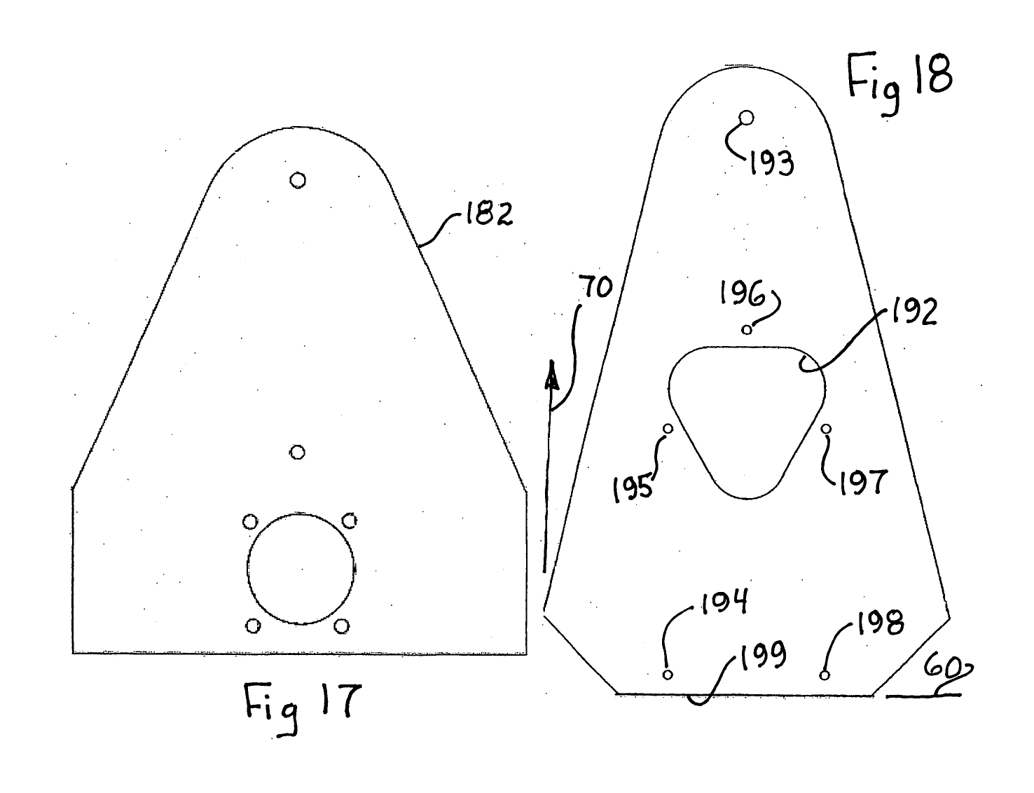

FIG. 18 sets forth a top view of the caster wheel support bracket 191 of the present invention stabilizing third wheel assembly for use in combination with a Powermate brand machine. Caster wheel support bracket 191 is shown having a bottom edge 199 positioned along horizontal axis 60. Caster wheel support bracket 191 defines a triangular trimmer shaft aperture 192. Caster wheel support bracket 191 further defines a plurality of apertures 194, 195, 196, 197 and 198 each having diameters of 0.34 inches and having aperture centers at coordinates (4.900,0.750). (4.878,10.125), (8,13.900), (11.125, 10.144) and (11.100,0.750). Caster wheel support bracket 191 further defines a caster wheel shaft aperture 193 having a diameter of 0.57 inches and an aperture center at (8,22).

FIG. 19 sets forth a top view of the caster wheel support bracket 201 of the present invention stabilizing third wheel assembly for use in combination with a Reminaton brand machine. Caster wheel support bracket 201 is shown having a bottom edge 208 positioned along horizontal axis 60 and a left side edge 209 positioned along vertical axis 70. Caster wheel support bracket 201 defines a trimmer shaft aperture 202 having a diameter of 5 inches and a center at (6.875,8.553). Caster wheel support bracket 201 further defines a plurality of apertures 204, 205, 206 and 207 each having diameters of 0.822 inches and having aperture centers at coordinates (1.750,1.000). (1.750,7.688), (11.662,9.167) and (14.030,3.200). Caster wheel support bracket 201 further defines a caster wheel shaft aperture 203 having a diameter of 0.57 inches and an aperture center at (4.800,22.5). Caster wheel support bracket 201 further defines an aperture 210 having a diameter of 0.54 inches and an aperture center at (11.375,12.500).

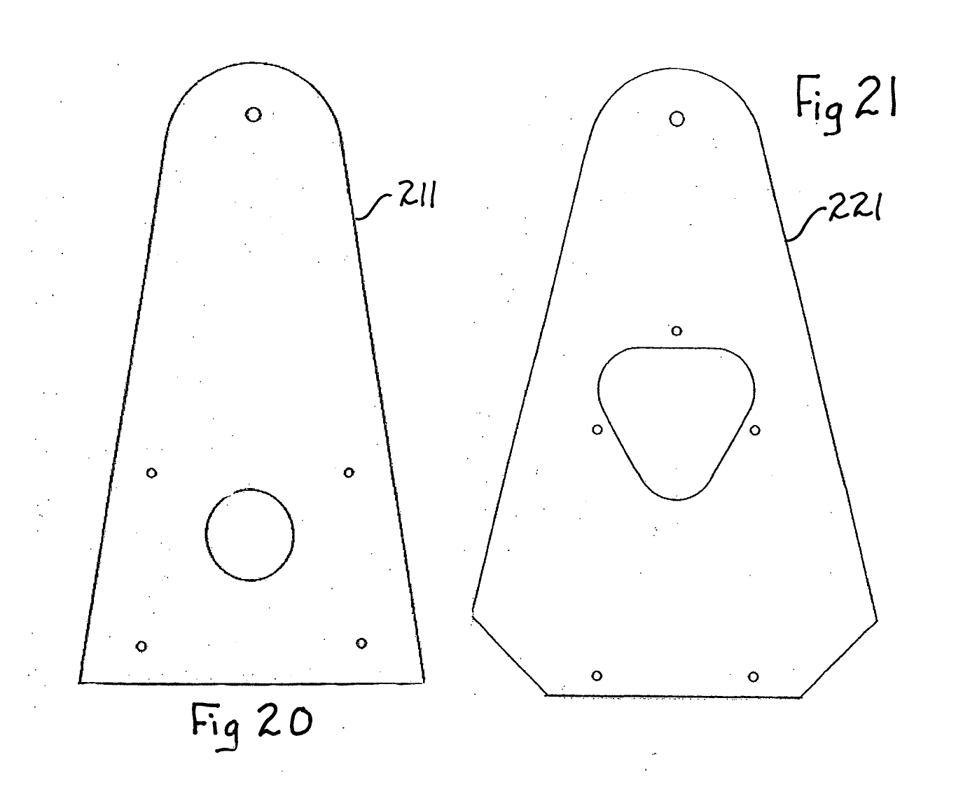

FIG. 20 sets forth a top view of the caster wheel support bracket 211 of the present invention stabilizing third wheel assembly for use in combination with a Sarlo brand machine. Caster wheel support bracket 211 is substantially identical to caster wheel support bracket 131 shown in FIG. 11.

FIG. 21 sets forth a top view of the caster wheel support bracket 221 of the present invention stabilizing third wheel assembly for use in combination with a Southland brand machine. Caster wheel support bracket 221 is substantially identical to caster wheel support bracket 191 shown in FIG. 18.

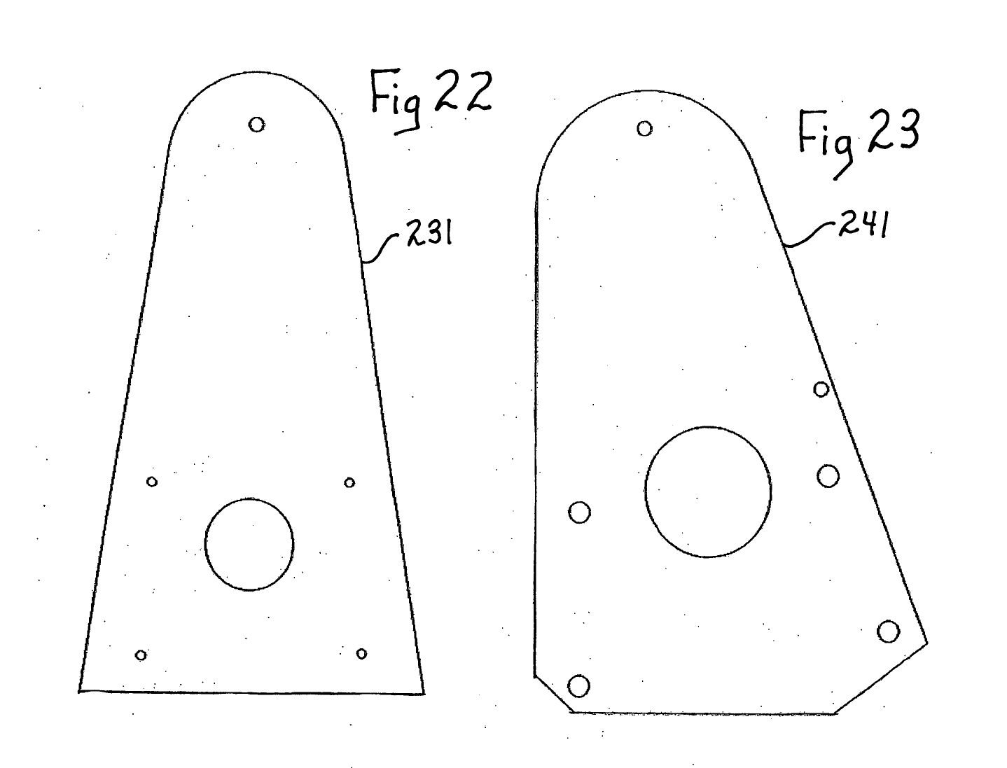

FIG. 22 sets forth a top view of the caster wheel support bracket 231 of the present invention stabilizing third wheel assembly for use in combination with a Swisher brand machine. Caster wheel support bracket 231 is substantially identical to caster wheel support bracket 131 shown in FIG. 11.

FIG. 23 sets forth a top view of the caster wheel support bracket 241 of the present invention stabilizing third wheel assembly for use in combination with a Troy Bilt brand machine. Caster wheel support bracket 241 is substantially identical to caster wheel support bracket 201 shown in FIG. 19.

What has been shown is a novel stabilizing third wheel assembly comprising a support bracket preferably formed of a suitable metal, such as steel or aluminum, or other material having efficient strength and rigidity, together with a caster wheel secured to the undersurface of the support bracket. In certain applications, a simple rotatably supported wheel may be utilized. However, it has been found that in the preferred fabrication of the present invention, a caster wheel is more suitable due to its ability to pivot in response to lateral forces as the user seeks to pivot and otherwise maneuver the host trimmer. The caster wheel extends downwardly a sufficient distance to maintain a clearance between the convex bumpers surface of the trimmer head thereby avoiding undesired contact between the bottom surface of the trimmer head and the underlying ground. The caster wheel functions to adjust the pitch and angle of the trimmer as variations of contour and elevation of the underlying terrain are encountered.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. For use in combination with a trimmer having an engine platform defining an undersurface, a protective shroud defining a bottom surface secured to said undersurface, an engine supported upon said engine platform, a trimmer head drive apparatus coupled to said engine, a trimmer head supported by said trimmer head drive apparatus beneath said undersurface, a stabilizing wheel and attachment comprising:
a plurality of extended length fasteners;
a caster wheel having a caster wheel attachment shaft extending therefrom; and
an attachment bracket formed of a substantially rigid high strength generally planar member defining a plurality of fastener apertures, a trimmer head aperture and a caster wheel attachment shaft aperture,
said attachment bracket being constructed to be received against said bottom surface of said protective shroud and secured to said engine platform by said plurality of extended length fasteners to captivate said protective shroud against said undersurface and said caster wheel being secured to said attachment bracket by the attachment of said caster wheel attachment shaft within said caster wheel attachment shaft aperture and said trimmer head drive apparatus extending through said trimmer head aperture.
